(19) United States
(12) Patent Application Publication
(10) Pub. No.: US 2024/0423183 A1
(43) Pub. Date: Dec. 26, 2024

(54) LINE GUIDE MECHANISM FOR SPINNING REEL

(71) Applicant: Shimano Inc., Osaka (JP)

(72) Inventor: Koji OCHIAI, Osaka (JP)

(21) Appl. No.: 18/628,535

(22) Filed: Apr. 5, 2024

(30) Foreign Application Priority Data
Jun. 22, 2023 (JP) 2023-102533

(51) Int. Cl. A01K 89/01

(52) U.S. Cl. CPC A01K 89/011222; A01K 89/011221

(57) ABSTRACT

A spinning reel for fishing includes a reel body including a main body portion and a cylindrical portion disposed in the main body portion, a rotor rotatably configured with respect to the reel body and including a body disposed radially outward from the cylindrical portion and a wall portion disposed in the rotor body portion and disposed opposite the cylindrical portion in an axial direction, and a waterproofing member disposed radially inward from the cylindrical portion, contacting the wall portion, and including a lubricant holding portion configured to hold a lubricant.

### CROSS-REFERENCE TO RELATED APPLICATIONS

This application claims priority to Japanese Patent Application No. 2023-102533, filed on Jun. 22, 2023. The entire disclosure of Japanese Patent Application No. 2023-102533 are hereby incorporated by reference.

### BACKGROUND

### Technical Field

The present disclosure relates to a spinning reel for fishing.

### Background Information

The spinning reel for fishing described in Japanese Patent Publication No. 2013-162761 includes a reel body, a rotor, a pinion gear, and a waterproofing member. The reel body has a main body portion and a cylindrical portion. The cylindrical portion is disposed in the main body portion.

The rotor has a rotor body portion and a front wall. The rotor body portion is disposed radially outward from the cylindrical portion. The front wall is provided on the rotor body portion. The front wall has a wall portion that is disposed opposite the cylindrical portion in the axial direction.

The pinion gear engages the rotor to rotate the rotor. The pinion gear is provided on the reel body so as to rotate about a spool shaft. The pinion gear is disposed inside the cylindrical portion of the reel body in the radial direction.

The waterproofing member is attached to the cylindrical portion of the reel body, inside the cylindrical portion of the reel body in the radial direction. The waterproofing member is disposed between the cylindrical portion of the reel body and the pinion gear in the radial direction.

The tip end portion of the waterproofing member has an annular shape. The tip end portion of the waterproofing member is fitted into a cap member that is disposed on the outer circumferential surface of the pinion gear. That is, the tip end portion of the waterproofing member is in contact with the outer circumferential surface of the cap member and presses the cap member radially inward.

### SUMMARY

It has been determined that in the spinning reel for fishing of the prior art, the tip end portion of the waterproofing member is fitted into the outer circumferential surface of the cap member, so that the tip end portion of the waterproofing member presses the cap member radially inward, which in turn presses the pinion gear radially inward. In other words, it has been determined that the waterproofing member can restrict the rotation of the pinion gear via the cap member.

Further, it has been determined that it is difficult to attach the waterproofing member to the cylindrical portion of the reel body so that the center of the annular waterproofing member coincides with the center of rotation of the pinion gear. Thus, if the center position of the waterproofing member is misaligned, there is the risk that waterproofing performance may not be sufficiently ensured. Therefore, in general, to maintain waterproofing performance, the amount of contact between the cap member and the pinion gear is increased to provide a certain amount of margin in anticipation of misalignment of the center position of the waterproofing member during assembly. In this case, the contact (amount of contact) between the cap member and the pinion gear is large, thereby increasing the rotational resistance.

The object of the present disclosure is to provide a spinning reel for fishing, the rotating structure of which can be rotated with a small amount of torque and the waterproofing performance of which can be stabilized.

According to a first aspect of the present disclosure, a spinning reel for fishing includes a reel body, a rotor, and a waterproofing member. The reel body has a main body portion and a cylindrical portion provided in the main body portion.

The rotor is configured to be rotatable with respect to the reel body. The rotor has a rotor body portion and a wall portion. The rotor body portion is disposed radially outward from the cylindrical portion. The wall portion is provided on the rotor body portion. The wall portion is disposed opposite the cylindrical portion in the axial direction.

The waterproofing member is disposed radially inward from the cylindrical portion. The waterproofing member has a lubricant holding portion that holds a lubricant. The waterproofing member is in contact with the wall portion.

In the spinning reel for fishing according to the first aspect, the wall portion of the rotor is disposed opposite the cylindrical portion of the reel body in the axial direction. The waterproofing member is disposed radially inward from the cylindrical portion of the reel body. In this state, the waterproofing member is in contact with the wall portion of the rotor.

Thus, in the spinning reel for fishing, there is no need to fit the waterproofing member into a rotation structure such as a pinion gear, so that the rotating structure can be rotated with a small amount of torque. Further, in the spinning reel for fishing, the center of the waterproofing member need not be precisely aligned with the center of rotation of the pinion gear, so that the waterproofing performance can be stabilized. Moreover, in the spinning reel for fishing, lower torque for the rotating structure and greater stability of waterproofing performance can be achieved due to the lubricant holding portion of the waterproofing member.

According to a second aspect of the present disclosure, the spinning reel for fishing according to the first aspect has the following configuration. The waterproofing member has a first convex portion and a second convex portion. The second convex portion is disposed radially inward from the first convex portion. The second convex portion is in contact with the wall portion. The lubricant holding portion is disposed between the first convex portion and second convex portion.

In spinning reel for fishing according to the second aspect, the lubricant can be suitably held by providing the lubricant holding portion between the first and second convex portions.

According to a third aspect of the present disclosure, the spinning reel for fishing according to the second aspect has the following configuration. The first convex portion and/or the second convex portion has a lip shape that becomes thinner toward the wall portion.

In the spinning reel for fishing according to the third aspect, the first convex portion and/or the second convex portion is lip-shaped, so that the contact resistance between the waterproofing member and the wall portion of the rotor can be reduced. In other words, the rotating structure can be rotated with a small amount of torque.

According to a fourth aspect of the present disclosure, the spinning reel for fishing according to any one of the first to third aspects has the following configuration. The wall portion has a collar member with which the waterproofing member is in contact.

In the spinning reel for fishing according to the fourth aspect, since the waterproofing member is in contact with the collar member of the wall portion, the contact resistance of the waterproofing member with the wall portion of the rotor can be reduced. That is, the rotating structure can be rotated with a small amount of torque.

### BRIEF DESCRIPTION OF THE DRAWINGS

FIG. 1 is a side view of a spinning reel for fishing according to an embodiment of the present disclosure.

FIG. 2 is a side view of the spinning reel for fishing with the side cover removed.

FIG. 3 is a cross-sectional view of the spinning reel for fishing.

FIG. 4 is a partially enlarged sectional view of the spinning reel for fishing.

FIG. 5 is a partially enlarged sectional view of FIG. 4.

FIG. 6 is an external perspective view of the first waterproofing member.

### DETAILED DESCRIPTION OF EMBODIMENTS

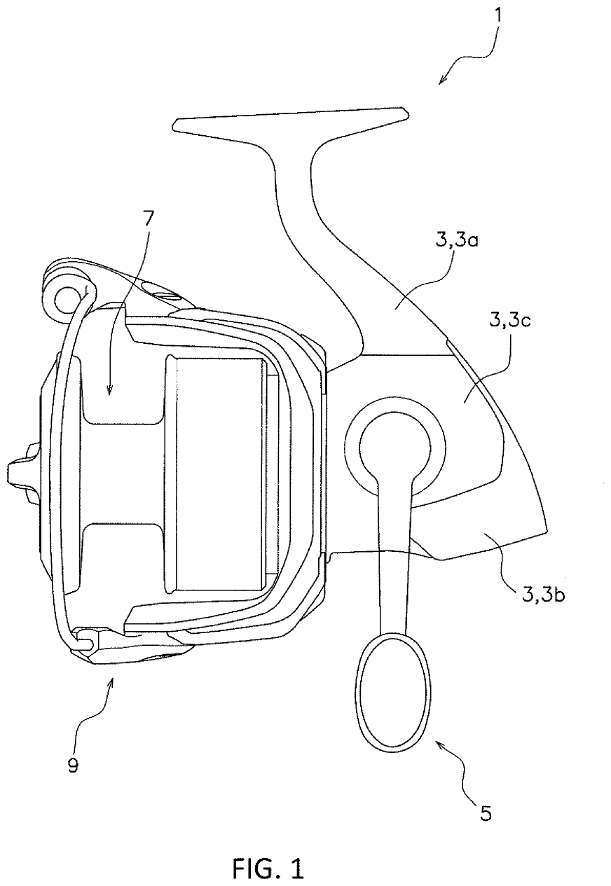

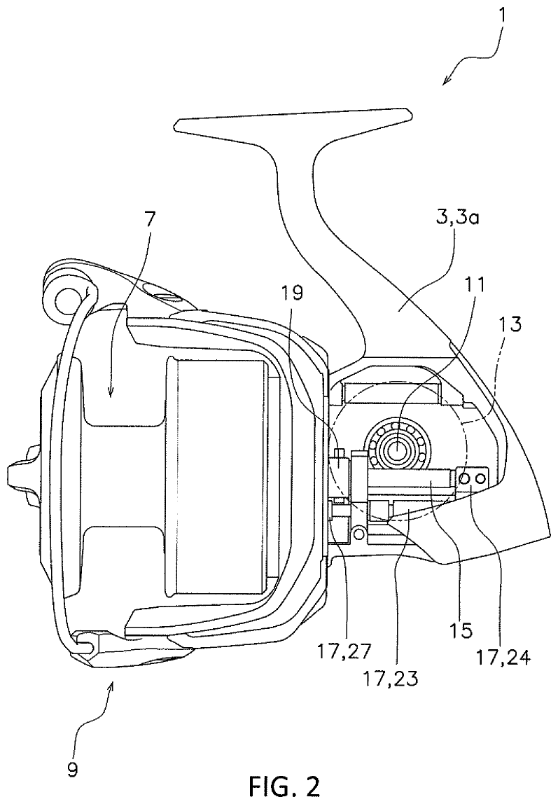

An embodiment of the spinning reel for fishing 1 according to the present disclosure will be described below with reference to the drawings. As shown in FIG. 1, the spinning reel for fishing 1 includes a reel body 3, a rotor 9, and a first waterproofing member 25 (see FIG. 2).

As shown in detail in FIG. 1, the spinning reel for fishing 1 includes a reel body 3, a handle 5, a spool 7, and a rotor 9. As shown in FIG. 2, the spinning reel for fishing 1 further includes a handle shaft 11, a drive gear 13, a spool shaft 15, and an oscillating mechanism 17. It should be noted that FIG. 2 is a diagram with the side cover 3c shown in FIG. 1 removed.

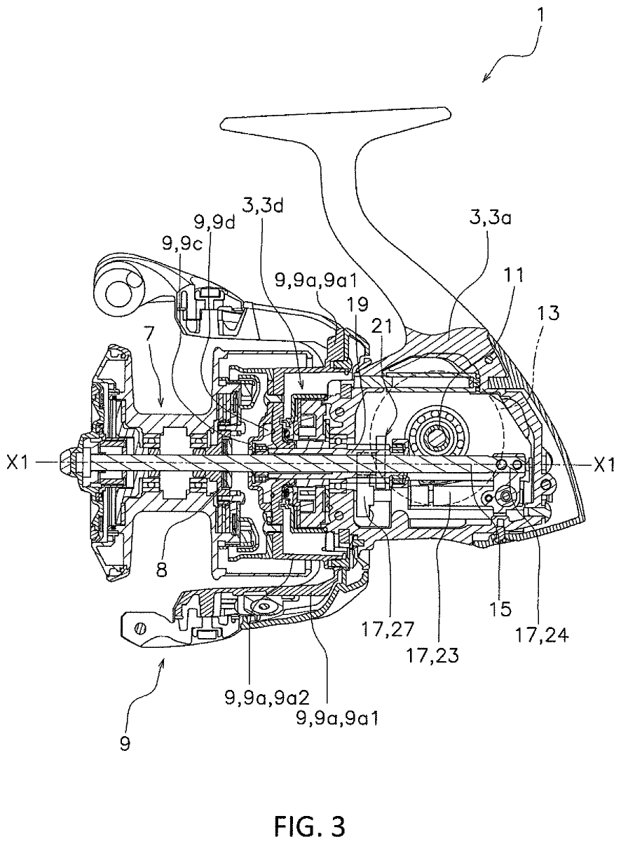

As shown in FIG. 3, the spinning reel for fishing 1 further includes a pinion gear 19 and a speed reduction mechanism 21. The spinning reel for fishing 1 further includes a first waterproofing member 25, a positioning member 29, and a second waterproofing member 31.

As shown in FIG. 1, the reel body 3 has a main body portion 3a, a body guard 3b, a side cover 3c, and a cover portion 3d (one example of the cylindrical portion) shown in FIG. 3. The body guard 3b is attached to the rear part of the main body portion 3a. The side cover 3c is attached to the side part of the main body portion 3a. A space is formed between the main body portion 3a and the side cover 3c to accommodate various mechanisms, described further below.

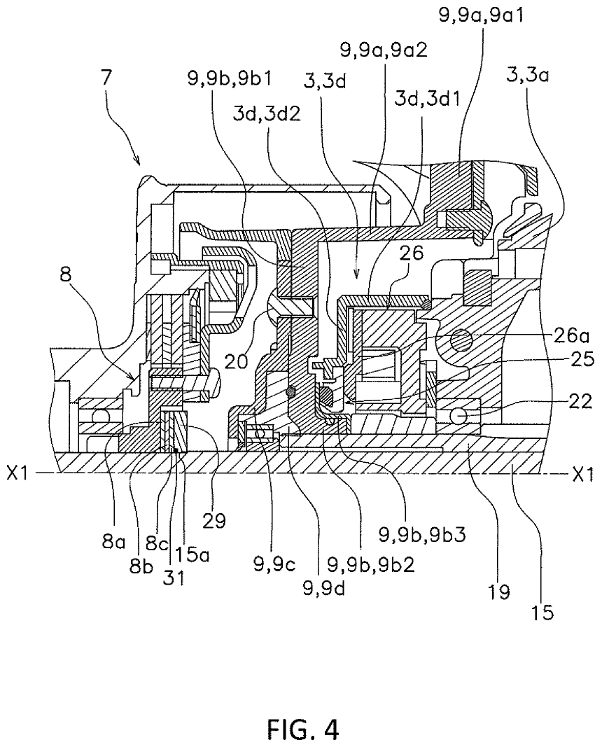

As shown in FIG. 3, the cover portion 3d is provided on the main body portion 3a. The cover portion 3d is fixed to the front part of the main body portion 3a. The cover portion 3d is formed in a cylindrical shape and has a bottom. Specifically, as shown in FIG. 4, the cover portion 3d has a first cylindrical portion 3dl and a bottom portion 3d2. The first cylindrical portion 3d1 is in the form of a cylinder.

As shown in FIG. 4, the first cylindrical portion 3dl is disposed at the front part of the main body portion 3a. The first cylindrical portion 3d1 is disposed radially inward from the second cylindrical portion 9a2 of the rotor 9. The bottom portion 3d2 has an annular shape. The spool shaft 15 and the pinion gear 19 are inserted into the inner circumferential portion of the bottom portion 3d2. The bottom portion 3d2 extends radially inward from the first cylindrical portion 3d1. The bottom portion 3d2 is fixed to the main body portion 3a by a fixing element such as a screw (not shown).

As shown in FIG. 1, the handle 5 is rotatably supported by the reel body 3. In the present embodiment, an example is shown in which the handle 5 is located on the left side of the reel body 3. The handle 5 can be placed on the right side of the reel body 3. The handle 5 is attached to the handle shaft 11 shown in FIG. 2.

As shown in FIGS. 2 and 3, the handle shaft 11 is rotatably supported by the reel body 3. The drive gear 13 is attached to the handle shaft 11 so as to be integrally rotatable with the handle shaft 11. The drive gear 13 engages the pinion gear 19.

Fishing line is wound around the spool 7 shown in FIG. 1. The spool 7 is connected to the spool shaft 15 shown in FIG. 2. Specifically, as shown in FIG. 3, the spool 7 is connected to the spool shaft 15 via a drag mechanism 8. The spool 7, together with the spool shaft 15, is moved in the front-rear direction with respect to the reel body 3 by the oscillating mechanism 17.

As shown in FIGS. 2 and 3, the spool shaft 15 is supported to be movable 3 in the front-rear direction with respect to the reel body. The spool shaft 15 passes through the inner circumferential portion of the cylindrical pinion gear 19. The spool shaft 15 moves back and forth with respect to the reel body 3 by the operation of the oscillating mechanism 17.

As shown in FIG. 3, the spool shaft 15 has a spool axis X1. Spool axis X1 is concentric with the axes of rotation at the centers of the spool 7, the rotor 9, and the pinion gear 19. Spool axis X1 extends in the front-rear direction. In the present embodiment, the front is the direction in which the fishing line is paid out (cast), for example, the left side of FIG. 1. The rear is opposite the front, for example, the right side of FIG. 1. Spool axis X1 extends in the axial direction. The radial direction is the direction away from spool axis X1. The circumferential and rotational directions are directions encircling spool axis X1.

As shown in FIGS. 2 and 3, the oscillating mechanism 17 moves the spool shaft 15 in the front-rear direction in conjunction with the rotation of the handle shaft 11. The oscillating mechanism 17 is disposed in the internal space of the reel body 3. The oscillating mechanism 17 comprises a worm shaft 23, a slider 24, and a worm shaft gear 27.

The worm shaft 23, shown in FIG. 3, rotates to move the spool shaft 15 and the slider back and forth. The worm shaft 23 is disposed parallel to the spool shaft 15. The worm shaft 23 is rotatably supported by the reel body 3.

The slider 24 is attached to the spool shaft 15. For example, the slider 24 is fixed to the rear end of the spool shaft 15. The slider 24 moves in the front-rear direction by the rotation of the worm shaft 23. The worm shaft gear 27 is disposed in front of the worm shaft 23. The worm shaft gear 27 is rotatably supported on the worm shaft 23.

As shown in FIG. 3, the pinion gear 19 is cylindrical in shape. The pinion gear 19 is rotatably supported by the reel body 3. The pinion gear 19 is disposed radially outwardly from the spool shaft 15. The pinion gear 19 rotates with respect to the spool shaft 15. The pinion gear 19 rotates around spool axis X1.

The outer peripheral surface of the front portion of the pinion gear 19 is non-circular in shape. More specifically, the outer peripheral surface of the front portion of the pinion gear 19 is ovular in shape and includes a pair of parallel surfaces and a pair of circular arcs. The front portion of the pinion gear 19, for example, the ovular portion, is the portion from the front end of the pinion gear 19 to the front surface of the bearing 22.

As shown in FIG. 3, the speed reduction mechanism 21 is disposed between the pinion gear 19 and the oscillating mechanism 17. For example, the speed reduction mechanism 21 is disposed between the pinion gear 19 and the worm shaft gear 27. The speed reduction mechanism 21 includes a plurality of gears. The speed reduction mechanism 21 reduces the rotation of the pinion gear 19 and transmits the reduced rotation to the oscillating mechanism 17.

When the handle shaft 11 is rotated by the turning of the handle 5, the drive gear 13 is rotated. The rotation of the drive gear 13 is transmitted to the pinion gear 19. The rotation of the pinion gear 19 is transmitted to the worm shaft gear 27 via the speed reduction mechanism 21. The rotation of the worm shaft 23 moves the slider 24 and the spool shaft 15 in the front-rear direction.

The rotor 9, shown in FIGS. 1 and 2, is used to wind fishing line around the spool 7. The rotor 9 is configured to rotate with respect to the reel body 3. Specifically, the rotor 9 is disposed in front of the reel body 3.

As shown in FIG. 3, the rotor 9 is disposed radially outward from the pinion gear 19. The rotor 9 is connected to the pinion gear 19 so as to rotate integrally with the pinion gear 19. When the handle shaft 11 rotates due to the turning of the handle 5, the drive gear 13 is rotated. The rotation of the drive gear 13 is transmitted to the pinion gear 19. The rotor 9 rotates in conjunction with the rotation of the pinion gear 19.

As shown in FIGS. 3 and 4, the rotor 9 includes a rotor body portion 9a, a front wall 9b (a wall portion), a retainer 9c, and a rotor nut 9d. The rotor body portion 9a is disposed radially outward from the cover portion 3d.

The rotor body portion 9a has a pair of arm portions 9al and a second cylindrical portion 9a2. Each of the pair of arm portions 9a includes an arm body, which is integrally formed with the second cylindrical portion 9a2 and extends forward from the rear end part of the second cylindrical portion 9a2, and a bail arm provided at the tip end of the arm body.

As shown in FIG. 4, the second cylindrical portion 9a2 is in the form of a cylinder. The second cylindrical portion 9a2 is disposed opposite the front portion of the main body portion 3a of the reel body 3 in the axial direction. The second cylindrical portion 9a2 is disposed radially outward from the cover portion 3d of the reel body 3. Specifically, the second cylindrical portion 9a2 is disposed radially outward from the first cylindrical portion 3dl of the cover portion 3d of the reel body 3.

As shown in FIG. 4, the front wall 9b is provided on the rotor body portion 9a. The front wall 9b is disposed opposite the cover portion 3d in the axial direction. Specifically, the front wall 9b includes a wall body 9b1, a support portion 9b2, and a rotor collar 9b3. The wall body 9b1 is annular in shape. The wall body 9b1 extends radially inward from the second cylindrical portion 9a2, and is disposed in front of the bottom portion 3d2 of the cover portion 3d.

The support portion 9b2 supports the rotor collar 9b3, and protrudes from the inner circumferential portion of the front wall 9b in the axial direction. Specifically, the support portion 9b2 protrudes rearwardly toward the main body portion 3a of the reel body 3 from the inner circumferential portion of the front wall 9b. The support portion 9b2 is disposed at the front portion of the pinion gear 19 and engages the outer peripheral surface of the front portion of the pinion gear 19 by a non-circular engagement.

The rotor collar 9b3 has an annular shape and extends circumferentially along the rear surface of the wall body 9b1, the upper surface of the support portion 9b2, and the rear surface of the support portion 9b2. The rotor collar 9b3 is held between the support portion 9b2 and the one-way clutch 26. Preferably, the rotor collar 9b3 is formed from metal, and the first waterproofing member 25 is in contact with the rotor collar 9b3.

As shown in FIG. 4, the retainer 9c is fixed to the front wall 9b of the rotor 9 by a fixing element 20 such as a screw. The retainer 9c holds the rotor nut 9d so as to rotate integrally with the rotor nut 9d. The rotor nut 9d engages the pinion gear 19 and rotates integrally with the pinion gear 19. Thus, when the pinion gear 19 rotates, the rotor body portion 9a and the front wall 9b rotate integrally with the pinion gear 19 via the retainer 9c and the rotor nut 9d.

As shown in FIG. 4, the first waterproofing member 25 contacts the front wall 9b, for example, the rotor collar 9b3. The first waterproofing member 25 is disposed inside the cover portion 3d in the radial direction. Specifically, the first waterproofing member 25 is disposed radially inwardly from the first cylindrical portion 3dl of the cover portion 3d. The first waterproofing member 25 is held between the bottom portion 3d2 of the cover portion 3d and the front portion of the main body portion 3a of the reel body 3 via the one-way clutch 26. The first waterproofing member 25 is preferably formed of synthetic resin.

The one-way clutch 26 is used to permit the reverse rotation of the rotor 9 or to prohibit the reverse rotation of the rotor 9. The one-way clutch 26 is disposed between the first cylindrical portion 3dl of the cover portion 3d and the pinion gear 19 in the radial direction. The one-way clutch 26 is disposed between the bottom portion 3d2 of the cover portion 3d and the front portion of the main body portion 3a in the axial direction. The one-way clutch 26 is fixed to the front of the main body portion 3a by a fixing element such as a screw (not shown).

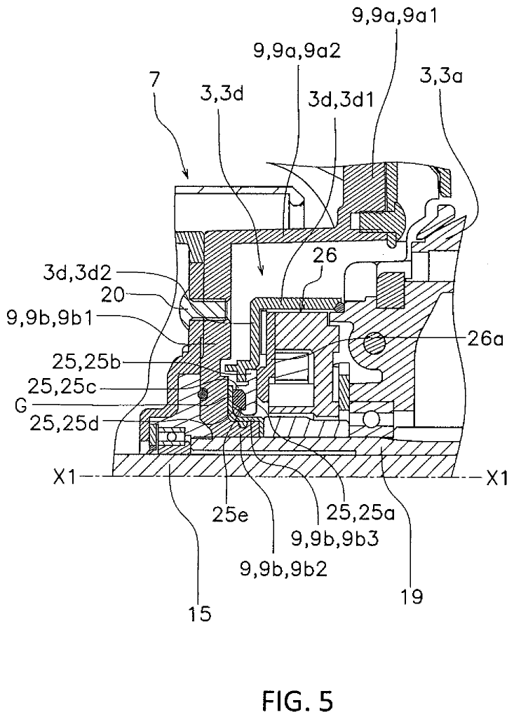

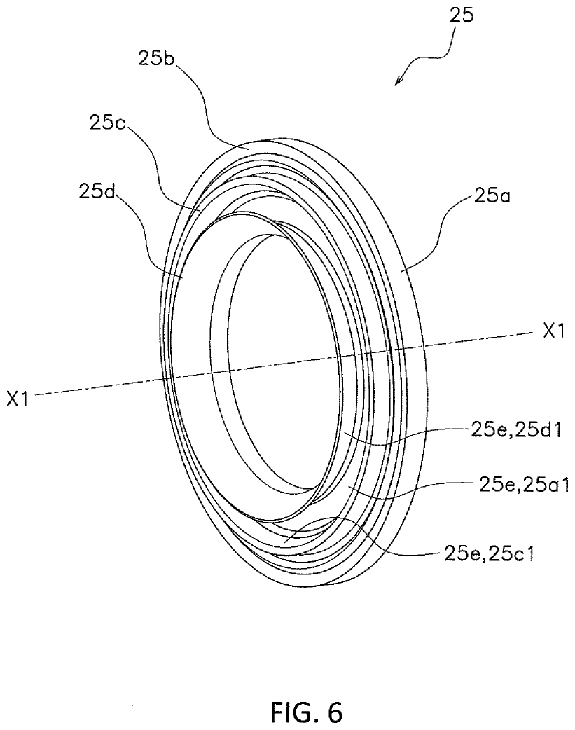

As shown in FIGS. 5 and 6, the first waterproofing member 25 comprises a first member main body portion 25a, a held portion 25b, a first convex portion 25c, a second convex portion 25d, and a lubricant holding portion 25e. The first member main body portion 25a has an annular shape. The held portion 25b forms the outer periphery of the first member main body portion 25a. The held portion 25b is held between the one-way clutch 26 and the bottom portion 3d2 of the cover portion 3d. Specifically, the held portion 25b is held between the shield member 26a of the one-way clutch 26 and the bottom portion 3d2 of the cover portion 3d.

The first convex portion 25c has an annular shape. The first convex portion 25c is provided on the first member main body portion 25a. Specifically, the first convex portion 25c is positioned more radially inward than the held portion 25b. More specifically, the first convex portion 25c protrudes from the first member main body portion 25a on the radially inward side of the held portion 25b. A gap is formed between the tip end portion of the first member main body portion 25a and the rotor collar 9b3 of the front wall 9b.

The second convex portion 25d is annular in shape and is provided on the first member main body portion 25a. Specifically, the second convex portion 25d is positioned radially inward from the first convex portion 25c. More specifically, the second convex portion 25d protrudes from the first member main body portion 25a on the radially inward side of the first convex portion 25c. The second convex portion 25d forms a lip shape that tapers from the base end portion to the tip end portion. The tip end portion of the second convex portion 25d is in contact with the rotor collar 9b3 of the front wall 9b.

In the present embodiment, an example is shown in which only the tip end portion of the second convex portion 25d is in contact with the front wall 9b (rotor collar 9b3), but the tip end portion of the second convex portion 25d and the tip end portion of the first convex portion 25c can both be in contact with the front wall 9b (rotor collar 9b3). Further, only the tip end portion of the first convex portion 25c can be in contact with the front wall 9b (rotor collar 9b3).

As shown in FIGS. 5 and 6, the lubricant holding portion 25e is configured to hold a lubricant G. The lubricant holding portion 25e is positioned between the first convex portion 25c and the convex portion 25d. Specifically, as shown in FIG. 6, the lubricant holding portion 25e is formed by an inner circumferential surface 25cl of the first convex portion 25c, the outer circumferential surface 25d1 of the second convex portion 25d, and the outer surface 25al of the first member main body portion 25a.

Lubricant G is held in the space of the lubricant holding portion 25c. Lubricant G includes grease. Preferably, while held in the lubricant holding portion 25c, lubricant G is in contact with the rotor collar 9b3 of the front wall 9b.

As shown in FIG. 4, the positioning member 29 is used to position the spool 7 with respect to the spool shaft 15 in the axial direction. The positioning member 29 is disposed on the outer peripheral surface of the spool shaft 15. The positioning member 29 is annular in shape.

In the present embodiment, the outer peripheral surface of the front portion of the spool shaft 15 is non-circular in shape. More specifically, the outer peripheral surface of the front portion of the spool shaft 15 is ovular in shape and includes a pair of parallel surfaces and a pair of circular arcs. The front portion of the spool shaft 15, for example, the ovular portion, is the portion from the front end of the spool shaft 15 to a position between the spool 7 and the rotor 9 (retainer 9c).

The positioning member 29 is annular in shape, and the inner peripheral surface of the positioning member 29 is engaged in non-circular fashion. More specifically, the inner peripheral surface of the positioning member 29 is ovular in shape and includes a pair of parallel surfaces and a pair of circular arcs. A recess 29a that extends along the inner peripheral surface of the positioning member 29 is formed in the inner peripheral surface thereof.

The inner peripheral surface of the positioning member 29 engages the outer peripheral surface of the spool shaft 15 by non-circular engagement. The positioning member 29 is disposed at the rear end 15a of the front portion (ovular portion) of the spool shaft 15. The rear end 15a of the front portion of the spool shaft 15 forms an annular step at the position between the spool 7 and the rotor 9 (retainer 9c). By arranging the positioning member 29 on the spool shaft 15 thusly, the positioning member 29 is engaged with the spool shaft 15 so as to be non-rotatable and non-movable rearwardly with respect to the spool shaft 15.

As shown in FIG. 4, the drag mechanism 8 includes a plurality of friction members 8a, 8b, 8c. The inner peripheral surfaces of the plurality of friction members 8a, 8b, 8c engage the outer peripheral surface of the spool shaft 15 by non-circular engagement, as in the case of the positioning members 29. The plurality of friction members 8a, 8b, 8c are disposed between the spool 7 and the positioning member 29 in the axial direction.

As shown in FIG. 4, the second waterproofing member 31 includes an O-ring. The second waterproofing member 31 is in contact with the outer peripheral surface of the spool shaft 15 and the rear surface of the friction member 8c. The second waterproofing member 31 is disposed between the outer peripheral surface of the spool shaft 15 and the positioning member 29 in the radial direction. Specifically, the second waterproofing member 31 is disposed between the outer peripheral surface of the spool shaft 15 and the recess 29a of the positioning member 29 in the radial direction. In this state, the second waterproofing member 31 is in contact with the outer peripheral surface of the spool shaft 15.

The second waterproofing member 31 is disposed between the rear surface of the friction member 8c and the front surface of the positioning member 29 in the axial direction. Specifically, the second waterproofing member 31 is disposed between the rear surface of the friction member 8c and the recess 29a of the positioning member 29 in the axial direction. In this state, the second waterproofing member 31 is in contact with the rear surface of the friction member 8c.

The above-described spinning reel for fishing 1 has the following features. In the spinning reel for fishing 1, since the first waterproofing member 25 need not be fitted into the pinion gear 19, the pinion gear 19 and the rotating member that operates in conjunction with the pinion gear 19 can be rotated with a small amount of torque. In the following, the pinion gear 19 and the rotating member that operates in conjunction with the pinion gear 19 are described as the rotating structure.

Further, in the spinning reel for fishing 1, the first waterproofing member 25 is in contact with the front wall 9b disposed in front of the first waterproofing member 25. In other words, since the center of the first waterproofing member 25 need not be precisely aligned with the center of rotation X1 of the pinion gear 19, the waterproofing performance can be stabilized. Moreover, in the spinning reel for fishing 1, the lubricant holding portion 25e of the first waterproofing member 25 can reduce the torque of the rotating structure and further stabilize the waterproofing performance.

In the spinning reel for fishing 1, lubricant G can be suitably held by providing the lubricant holding portion 25e between the first convex portion 25c and the second convex portion 25d.

In the spinning reel for fishing 1, since the first convex portion 25c and/or the second convex portion 25d forms a lip shape that tapers toward the front wall 9b, the contact resistance between the first waterproofing member 25 and the front wall 9b of the rotor 9 can be reduced. In other words, the rotating structure can be rotated with a small amount of torque.

In the spinning reel for fishing 1, since the first waterproofing member 25 is in contact with the rotor collar 9b3 of the front wall 9b, the contact resistance between the first waterproofing member 25 and the front wall 9b of the rotor 9 can be reduced. In other words, the rotating structure can be rotated with a small amount of torque.

In the spinning reel for fishing 1, since the second waterproofing member 31 is disposed in the recess 29a of the positioning member 29 and contacts the outer peripheral surface of the spool shaft 15 and the rear surface of the friction member 8c, water can be prevented from entering into the interior of the spool 7 from the rear surface of the positioning member 29.

The present disclosure can be used in spinning reels for fishing.

What is claimed is:

1. A spinning reel for fishing, comprising:
a reel body including a main body portion and a cylindrical portion disposed in the main body portion;
a rotor configured to rotate with respect to the reel body and including a rotor body portion disposed radially outward from the cylindrical portion and a wall portion disposed in the rotor body portion and disposed opposite the cylindrical portion in an axial direction; and
a waterproofing member disposed radially inward from the cylindrical portion, contacting the wall portion, and including a lubricant holding portion configured to hold a lubricant.

2. The spinning reel for fishing according to claim 1, wherein
the waterproofing member has a first convex portion and a second convex portion disposed radially inward from the first convex portion and contacting the wall portion, and
the lubricant holding portion is disposed between the first convex portion and the second convex portion.

3. The spinning reel for fishing according to claim 2, wherein
the first convex portion or the second convex portion forms a lip shape that tapers toward the wall portion.

4. The spinning reel for fishing according to claim 1, wherein
the wall portion has a collar member contacting the waterproofing member.
